(19) United States
(12) Patent Application Publication
(10) Pub. No.: US 2006/0147654 A1
(43) Pub. Date: Jul. 6, 2006

(54) Wreath mounting frame for double doors

(76) Inventors: Stanley E. Bopp, Cape Coral, FL (US); Janet Bopp, Cape Coral, FL (US)

Correspondence Address: Stanley E. Bopp, 229 SE 14th Street, Cape Coral, FL, 33990, US

(21) Appl. No.: 11/136,772

(22) Filed: May 26, 2005

Related U.S. Application Data
(60) Provisional application No. 60/640,303, filed on Jan. 3, 2005.
(60) Provisional application No. 60/649,303, filed on Feb. 2, 2005.

(51) Int. Cl. G09F 19/00; A47G 35/00

(52) U.S. Cl. 428/10; 428/542.2

(57) ABSTRACT

A decorative wreath is mounted over the edges of panels of double doors. The wreath is mounted in such a manner so that two individual half circular frame sections of the decorative wreath will separate from each other. Each half circular frame section consists of spaced apart wire sections that form a three dimensional cage which can be intertwined with decorative material. Each of the half circular frame sections can be separably mounted onto each panel of the double doors. The separably mounting can be a hook and loop fastening system, an adhesive fastening system or magnets. When the double doors are closed, the inner ends of the half circular frame sections are adjacent to each other to give the visual impression of a complete circle of a decorative wreath.

### REFERENCE TO RELATED APPLICATIONS

This application is a Continuation-In Part of the Provisional Application No. 60/649,303, filed on Jan. 3, 2005

### FIELD OF THE INVENTION

The present Invention relates to a decorative wreath mounting systems and, more particularly, to a bifurcated frame that may be circular or any other shape, comprised of two detachably mounted but adjoining sections that are mounted on each side of a double entrance door, also known as “French Doors”. The two adjoining sections are independent of each other and may separate temporarily as the door is opened and joined up again adjacent to each as the door is closed.

### BACKGROUND OF THE INVENTION

Decorative wreaths are traditionally displayed during holiday seasons and times of mourning or to signify notable events or occasions. Circular wreaths have appeared throughout history and have become associated with events of great moment. Their construction has evolved from a simple intertwining of laurel or holly branches to form their characteristic shape, elaborate framed configurations, replete with mounting hardware or hanging systems. These traditional shapes do not lend themselves to mounting upon the front doors of dwellings where such doors are centrally divided as they often are in larger homes with formal entryways. The current practice is to mount a pair of smaller wreaths, one to each side of the door, or to mount a larger wreath over the center of the two doors such that it is entirely attached to one side of the door and moves as the door is opened. The latter allows for a larger, more symmetrical display but has the inconvenience of having to be maneuvered each time the door is open and at holiday times, with guests arriving, this is an inelegant configuration.

U.S. Pat. No. 4,942,692 illustrates a wire frame for supporting a living plant wreath made of three pairs of concentric wire rings. While this wreath frame could be mounted on a door for display, there is no teaching that it should be split into two sections to be mounted on double doors.

U.S. Pat. No. 6,017,132 discloses a decorative light-supporting structure in the form of a wreath that can be made up of several sections. It can be mounted on a door but does include any teachings to be split and mounted on a double door.

U.S. Pat. No. 6,667,079 shows a frame work for an artificial wreath that can be mounted on any surface including a door. The wreath cannot be split into two sections so that it can be mounted on double doors.

U.S. Pat. No. 6,667,109 illustrates a decorative medallion that is split in two halves that can be assembled into a circular piece to be used to accent or enhance the appearance of a ceiling light fixture. There is no teaching or suggestion that this device can be used to separate a wreath on a double door into two pieces.

U.S. Pat. No. 6,685,340 discloses an outdoor decoration, primarily intended for the holiday season including a wire frame that is divided into segments, the segments having either the same size or with as many segments as possible. The segments are made so as permit the segments together for convenient shipping. The segments cannot be used to form a wreath to be mounted on a double door.

### BRIEF DESCRIPTION OF THE INVENTION

The present invention provides a mounting system comprised of a pair of generally concentric circular frames held apart and separated by a plurality of cross beams or legs. The circular half frame sections are separated along their vertical axes such that each vertical semicircular portion may be mounted to each of the separate door panels and aligned vertically with the adjoining edges of the two doors. This configuration lends itself to a variety of mounting means from a simple suspension strap over the top of the door to a more secure mounting using detachable hook and loop tabs, adhesive tabs or magnets on metal doors. A preferred mounting method is to pre-attach mounting points on each of the doors, decorate each half of the wreath frame, attach each to the mounting points and complete the symmetry and the illusion that the wreath is a single unit by attaching a. two-piece ribbon over the central axis of the wreath.

### BRIEF DESCRIPTION OF THE DRAWINGS

FIG. 1 is a frontal view of the assembled wreath on a double door;

FIG. 2 is an isometric view, partially in section of the wreath mounting frame;

FIG. 3 is an exploded isometric view of the wreath mounting frame;

FIGS. 4-9 are a sequential series of frontal views of the installation process.

### DETAILED DESCRIPTION OF THE INVENTION

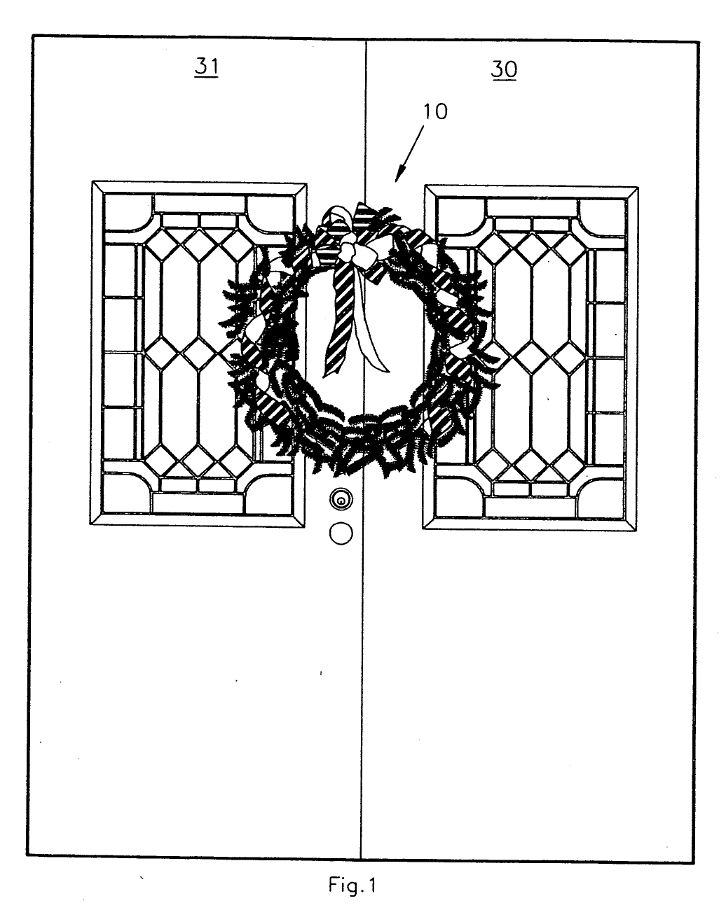

Referring now to the drawings in which like numerals designate like and corresponding elements throughout the several views. In FIG. 1 the inventive concept of the wreath is designated by the numeral 10 which is mounted centrally between the door panels 30 and 31.

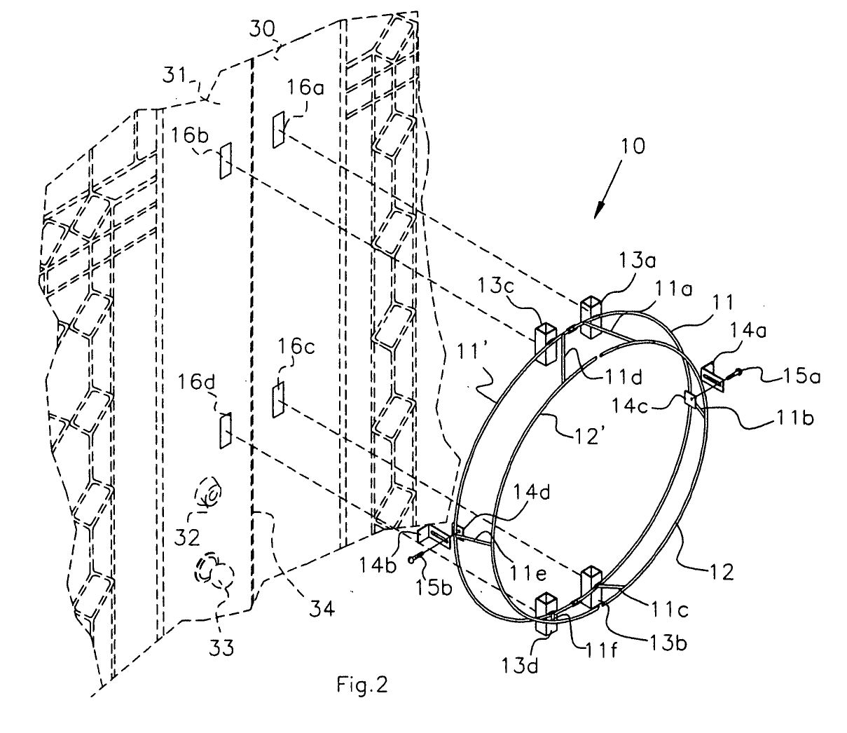

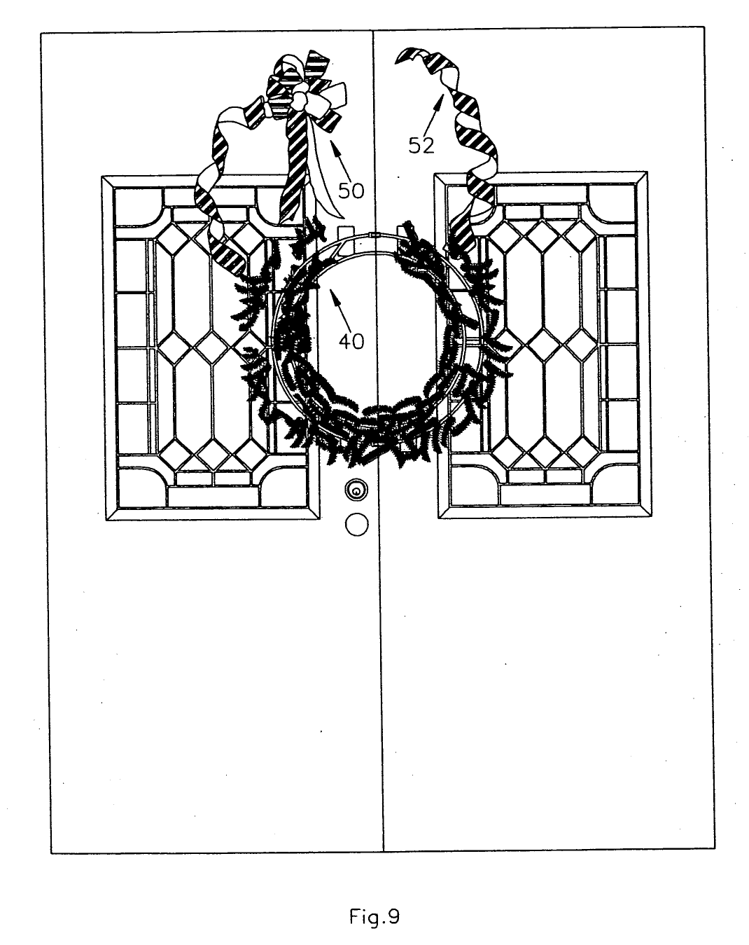

FIG. 2 shows the door mounts 16a, b, c and d. The door mounts can be attached in various ways. For example, they can be the well known hook and loop fastening system or by adhesive non-damaging strips. In the case of decorative metal doors, no mountings on either door 30 and 31 are required. The magnets would be located on the frame of the wreath configuration. The wreath frame itself consists of two circular halves 12 and 12′. At the rear of each of the halves 12 and 12′ there are mounted or attached thereto mounting blocks 13a, b, c and d. Each of the blocks have attached thereto the corresponding elements of each of the fastening systems described above. Thus, each of the blocks would have the other element of the hook and loop fastening system or a corresponding element of an adhesive fastening system, for example. In case of metal doors, it would suffice that a corresponding magnetic strip be attached to each of the blocks, 13a, b, c and d. The requirement for each of the attachment means are that they are non-marring, and retain the wreath assembly in place even as the doors are opened and closed. Slotted spacer attachments 14a and 14b attach to tabs 14d and 14e with screws 15a and 15b to act as a third contact point against the door panels 30 and 31. Wreath unit 10 is mounted above and clears the door lock 32 and the door handle 33. Spacer beams 11a, b, c, d, e and f are welded between frame sections 11 and 11′ and 12′ and 12′. The inner frame sections 11 and 11′ display a larger circular circumference than the outer frame sections 12 and 12′. Spacing the frame sections in this fashion provides mounting surfaces or areas for the decorating elements, which are spaced away from the surfaces of the door panels 30 and 31. For a decorative wreath 40 and ribbon sections 51 and. 52, see FIG. 9.

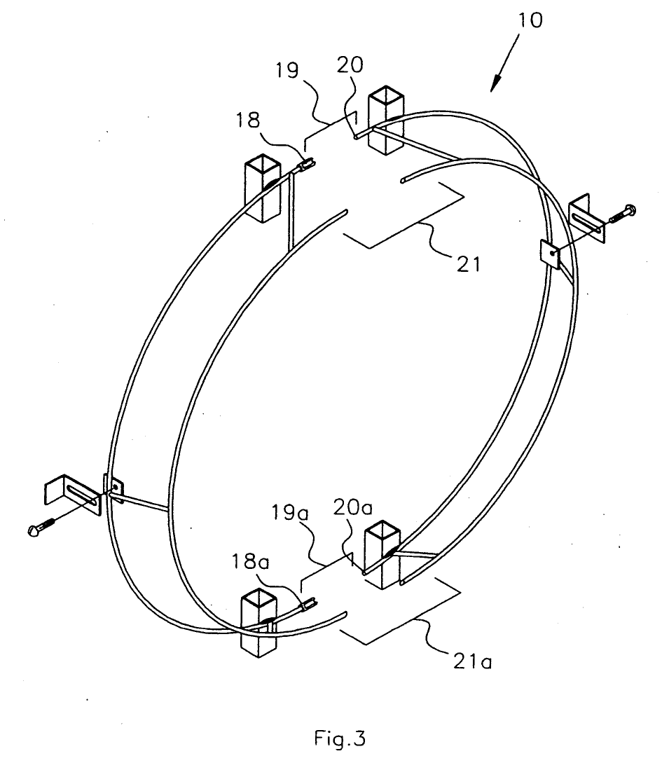

FIG. 3 illustrates gaps 19 and 19a and 21 and 21a that separate the two halves 11, 11′ and 12, 12′ (FIG. 2) of the wreath unit allowing the halves of the wreath unit to be mounted independently and spaced apart such when the door panels 30 and 31 are moved, frame ends 20 and 20a can move away from a mated position in retainers 18 and 18a. This connection thus described is not a joining of the two halves of the frame but are a temporary mating as ends 20 and 20a slot into the openings of 18 and 18a. On the other hand, the slots 18 and 18a could be constructed in such a manner so that the frame ends 20 and 20a could snap fit into the slots 18 and 18a to thereby form a complete unit of a wreath. Such a wreath could be installed on any flat surface including a single door without being able to or having to be separated from each other.

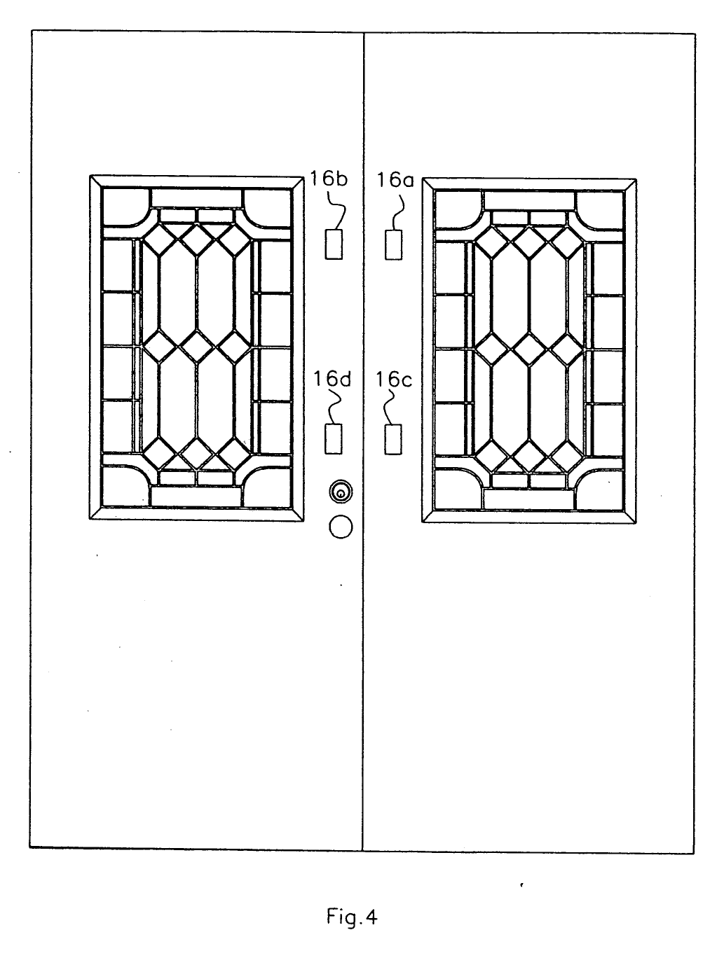

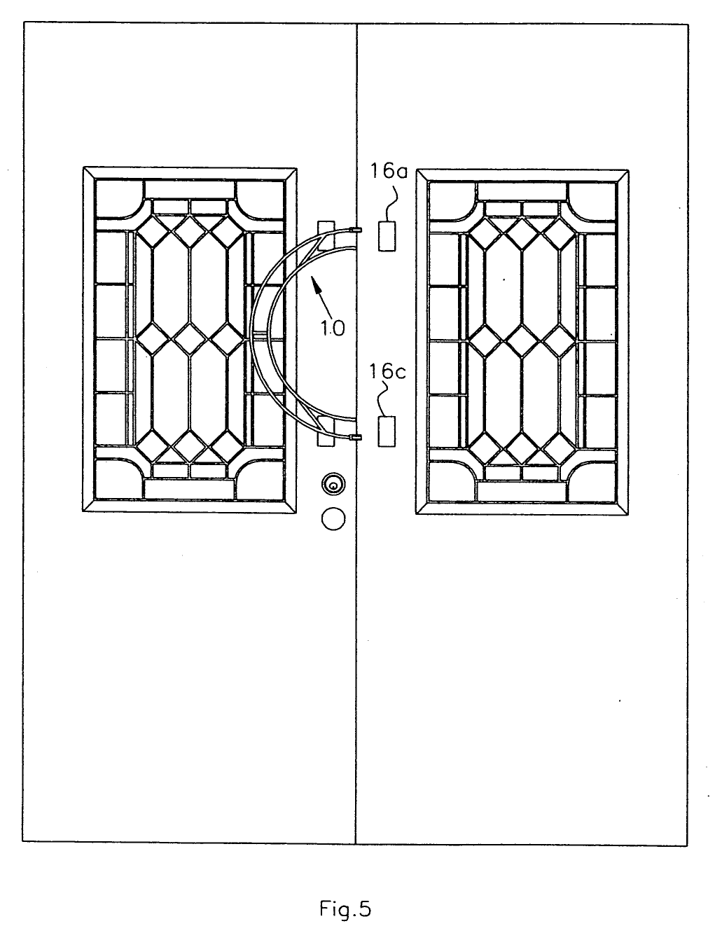

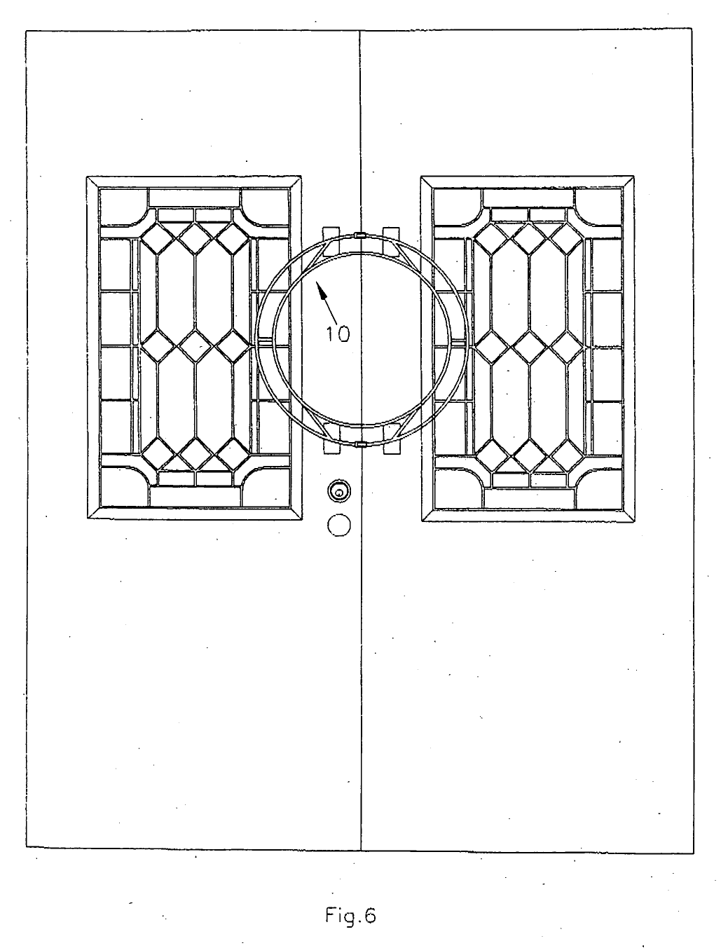

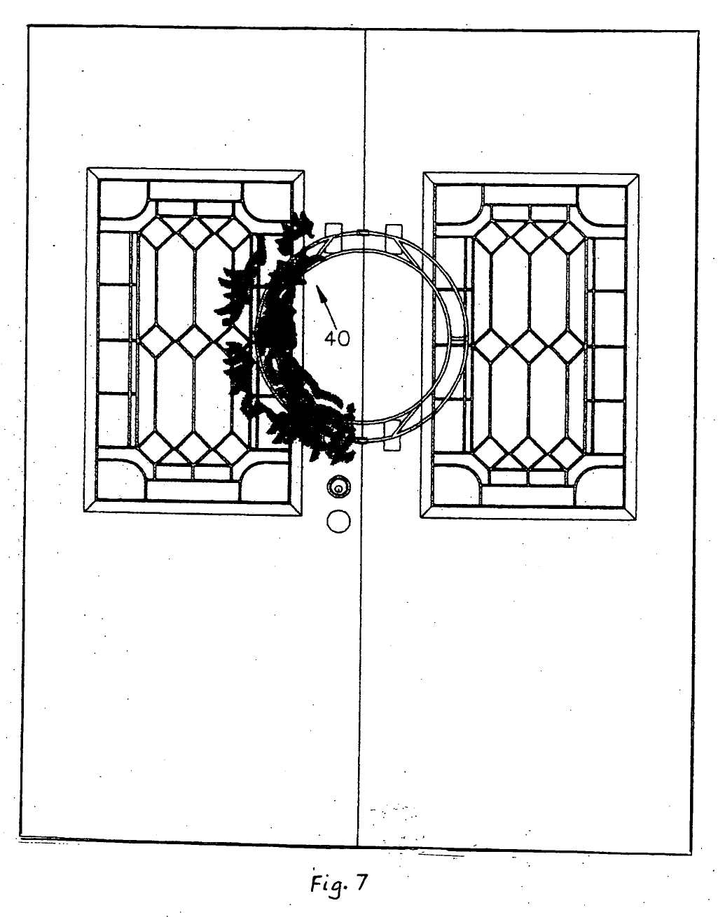

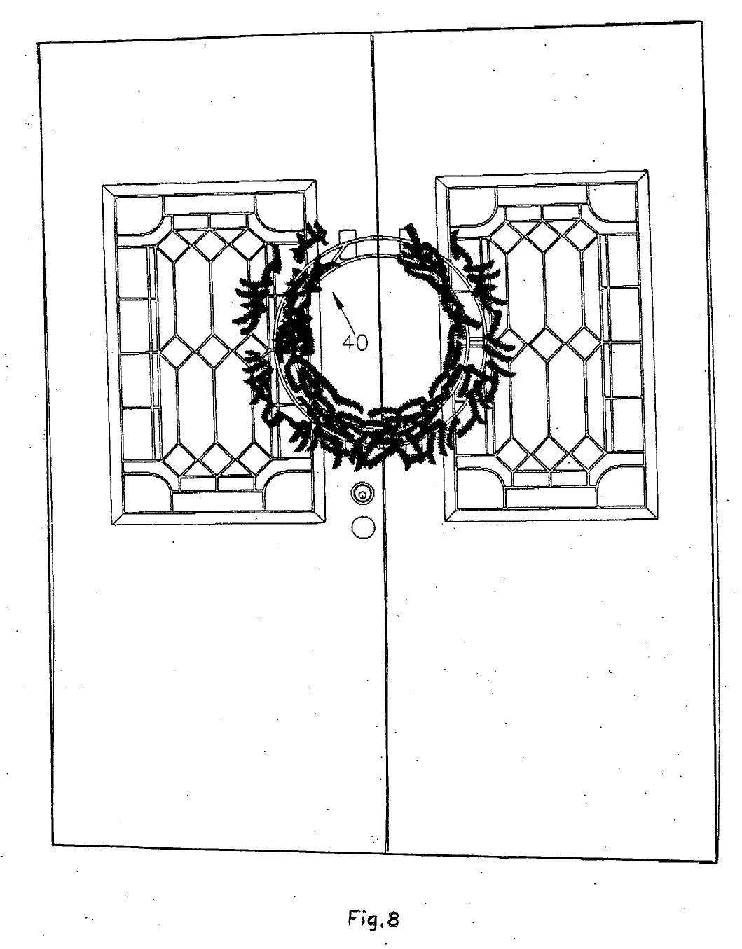

FIGS. 4-9 illustrate a possible mounting sequence for each wreath section or component which begins in Fig. in which the mounting points 16a, b, c and d are attached the 30 and 31 first. The sequence of mounting progresses with the subsequent mounting of one half of the frame section (FIG. 5) and thereafter the other half of the other frame section (FIG. 6). FIG. 7 shows where the decorating material of the wreath 40 is first attached or intertwined to the first half of the frame and FIG. 8 shows where the second half of the frame is being finished with the decorating material. FIG. 9 shows the finished wreath with the addition of ribbons being attached to complete an attractive holiday display.

In operation, as the doors 30 or 31 or both are opened, the wreath halves will separate cleanly while remaining securely attached to each of the door panels and return to their former position as the door is or are closed.

What we claim is:

1. A decorative wreath mounted over two edges of double door panels consisting of two half circular frame sections, said two circular frame sections having means thereon for being separably attached to said door panels, said two half circular frame sections are mounted over said two edges of said double door panels so that inner ends of said half circular frame sections are located adjacent to each other to thereby give a visual impression of a complete circular appearance, decorative material is intertwined within said half circular frame sections.

2. The decorative wreath of claim 1, wherein said means for separably attaching is a hook and loop fastening system.

3. The decorative wreath of claim 1, wherein said means for separably fastening is an adhesive fastening system.

4. The decorative wreath of claim 1, wherein said means for separably fastening is a magnetic fastening system.

5. The decorative wreath of claim 1, wherein each of said half circular frame sections consists of an inner half circular wire and an outer half circular wire being spaced from each other away from said double doors.

6. The decorative wreath of claim 5, wherein said inner halt circular wire has a larger diameter than said outer half circular wire.

7. The decorative wreath of claim 1 including means for spacing said two half circular frame sections from said double door sections.

8. The decorative wreath of claim 1 including means for temporarily attaching inner ends of said two half circular sections to each other when said double door panels are closed.
